(19) United States
(12) Patent Application Publication
(10) Pub. No.: US 2011/0108056 A1
(43) Pub. Date: May 12, 2011

(54) CLEANING METHOD FOR TRANSFER ARM, CLEANING METHOD FOR SUBSTRATE PROCESSING APPARATUS AND SUBSTRATE PROCESSING APPARATUS

(75) Inventors: Shigeru Ishizawa, Nirasaki (JP); Masaki Kondo, Nirasaki (JP)

(73) Assignee: TOKYO ELECTRON LIMITED, Tokyo (JP)

(21) Appl. No.: 12/940,270

(22) Filed: Nov. 5, 2010

(30) Foreign Application Priority Data
Nov. 9, 2009 (JP) 2009-256300

(51) Int. Cl. B08B 7/00

(52) U.S. Cl. 134/1; 15/1.51

(57) ABSTRACT

There is provided a substrate processing apparatus cleaning method for removing contaminants adhered on a transfer arm. The cleaning method for the transfer arm that transfers a substrate and has an electrostatic chuck includes a voltage applying process for applying, when electrically charged contaminants are adhered on the transfer arm and the substrate is not mounted on the transfer arm, a voltage of the same polarity as that of the electrically charged contaminants to each electrode of the electrostatic chuck, to thereby remove the contaminants adhered on the transfer arm.

### CROSS-REFERENCE TO RELATED APPLICATION

This application claims the benefit of Japanese Patent Application No. 2009-256300 filed on Nov. 9, 2009, the entire disclosures of which are incorporated herein by reference.

### FIELD OF THE INVENTION

The present disclosure relates to a cleaning method for a transfer arm and a cleaning method for a substrate processing apparatus and, also, relates to a substrate processing apparatus.

### BACKGROUND OF THE INVENTION

In manufacturing a semiconductor device, a film forming process, a reforming process, an oxidation/diffusion process, an annealing process and an etching process for various kinds of thin films is repetitively performed on the semiconductor wafer in sequence. By such processes, the semiconductor device having multiple layers is formed on a semiconductor wafer.

As a manufacturing apparatus for manufacturing such a semiconductor device, there has been known a substrate processing apparatus of a single sheet type. In this single-sheet-type substrate processing apparatus, a plurality of processing chambers for performing various processes is connected to a transfer chamber and the various processes are performed on a semiconductor wafer within the respective processing chambers in sequence, and, thus, the various processes can be carried out by the single substrate processing apparatus. In the single-sheet-type substrate processing apparatus, the semiconductor wafer is transferred between the processing chambers through extension/retraction and rotation of a transfer arm installed in the transfer chamber. Typically, the transfer arm has an electrostatic chuck function, and the semiconductor wafer is attracted to and held on the transfer arm by the electrostatic chuck function and then is transferred.

In the substrate processing apparatus, however, since the transfer arm has a driving mechanism, foreign substances such as contaminants may be generated if the substrate processing apparatus is used for a long time. Further, when a film forming process is performed in a processing chamber of the substrate processing apparatus, a film adhered to a wall surface of the processing chamber during the film forming process may be peeled off, resulting in generation of contaminants. The generated contaminants may adhere to the transfer arm or the semiconductor substrate while floating within the chamber. If the contaminants are adhered to the transfer arm due to the contaminants of the transfer arm, the contaminants may also be adhered to the semiconductor wafer transferred by the transfer arm, resulting in decrease of yield of semiconductor devices as in the case that contaminants are directly adhered to the semiconductor wafer.
Patent Document 1: Japanese Patent Laid-open Publication No. H6-252066
Patent Document 2: Japanese Patent Laid-open Publication No. H7-302827

In order to remove the contaminants generated by the aforementioned reasons, the transfer arm to which contaminants are adhered may be taken out of the chamber, and the contaminants on a surface of the transfer arm may be cleaned and removed. However, since the transfer arm needs to be taken out of the chamber of the substrate processing apparatus, it would take time and effort. Especially, it would take more time and effort to take out the transfer arm installed in a vacuum chamber because the inside of the vacuum chamber needs to be turned into an atmospheric pressure. Further, in order to remove contaminants floating within the chamber, it has been attempted to clean an internal wall of the chamber, which also turns out to be time-consuming and effortful. Besides, other contaminants may be adhered while the contaminants are being cleaned off as described above.

### BRIEF SUMMARY OF THE INVENTION

In view of the foregoing, there has been an increasing demand for a method for easily and quickly removing contaminants adhered to the transfer arm without taking the transfer arm out of the chamber of the substrate processing apparatus and, also, for a method for easily and quickly removing contaminants floating within the chamber.

In accordance with a first aspect of the present disclosure, there is provided a cleaning method for a transfer arm that transfers a substrate and has an electrostatic chuck. The cleaning method includes a voltage applying process for applying, when electrically charged contaminants are adhered on the transfer arm and the substrate is not mounted on the transfer arm, a voltage of the same polarity as that of the electrically charged contaminants to each electrode of the electrostatic chuck, to thereby remove the contaminants adhered on the transfer arm.

In accordance with a second aspect of the present disclosure, there is provided a cleaning method for a transfer arm that transfers a substrate and has an electrostatic chuck. The cleaning method includes a first voltage applying process for applying a positive voltage to one of electrodes of the electrostatic chuck and applying a negative voltage to the other one of the electrodes of the electrostatic chuck while the substrate is not mounted on the transfer arm; and a second voltage applying process for applying a negative voltage to the one electrode of the electrostatic chuck and applying a positive voltage to the other electrode of the electrostatic chuck after the first voltage applying process, to thereby remove contaminants around the transfer arm.

In accordance with a third aspect of the present disclosure, there is provided a cleaning method for a substrate processing apparatus including a plurality of processing chambers for performing a process on a substrate, a transfer chamber connected to the plurality of processing chambers, and a transfer arm installed in the transfer chamber to transfer the substrate between the processing chambers and having an electrostatic chuck. The cleaning method includes a voltage applying process for applying, when electrically charged contaminants are adhered on the transfer arm and the substrate is not mounted on the transfer arm, a voltage of the same polarity as that of the electrically charged contaminants to each electrode of the electrostatic chuck, to thereby remove the contaminants adhered on the transfer arm.

In accordance with a fourth aspect of the present disclosure, there is provided a cleaning method for a substrate processing apparatus including a plurality of processing chambers for performing a process on a substrate, a transfer chamber connected to the plurality of processing chambers, a load lock chamber connected to the transfer chamber, and a transfer arm installed in the transfer chamber to transfer the substrate between the processing chambers and the load lock chamber and having an electrostatic chuck. The cleaning method includes a voltage applying process for applying, when electrically charged contaminants are adhered on the transfer arm and the substrate is not mounted on the transfer arm, a voltage of the same polarity as that of the electrically charged contaminants to each electrode of the electrostatic chuck, to thereby remove the contaminants adhered on the transfer arm.

In accordance with a fifth aspect of the present disclosure, there is provided a cleaning method for a substrate processing apparatus including a plurality of processing chambers for performing a process on a substrate, a transfer chamber connected to the plurality of processing chambers, and a transfer arm installed in the transfer chamber to transfer the substrate between the processing chambers and having an electrostatic chuck. The cleaning method includes a first voltage applying process for applying a positive voltage to one of electrodes of the electrostatic chuck while applying a negative voltage to the other one of the electrodes of the electrostatic chuck while the substrate is not mounted on the transfer arm; and a second voltage applying process for applying a negative voltage to the one electrode of the electrostatic chuck while applying a positive voltage to the other electrode of the electrostatic chuck after the first voltage applying process, to thereby remove electrically charged contaminants in the processing chambers or in the transfer chamber.

In accordance with a sixth aspect of the present disclosure, there is provided a cleaning method for a substrate processing apparatus including a plurality of processing chambers for performing a process on a substrate, a transfer chamber connected to the plurality of processing chambers, a load lock chamber connected to the transfer chamber, and a transfer arm installed in the transfer chamber to transfer the substrate between the processing chambers and the load lock chamber and having an electrostatic chuck. The cleaning method includes a first voltage applying process for applying a positive voltage to one of electrodes of the electrostatic chuck and applying a negative voltage to the other one of the electrodes of the electrostatic chuck while the substrate is not mounted on the transfer arm; and a second voltage applying process for applying a negative voltage to the one electrode of the electrostatic chuck while applying a positive voltage to the other electrode of the electrostatic chuck after the first voltage applying process, to thereby remove electrically charged contaminants in the processing chambers or in the transfer chamber.

In accordance with a seventh aspect of the present disclosure, there is provided a cleaning method for a substrate processing apparatus including a plurality of processing chambers for performing a process on a substrate, a transfer chamber connected to the plurality of processing chambers, and a transfer arm installed in the transfer chamber to transfer the substrate between the processing chambers and having an electrostatic chuck. The cleaning method includes a transfer arm inserting process for inserting a part of the transfer arm having the electrostatic chuck into the processing chamber from the transfer chamber while the substrate is not mounted on the transfer arm; a voltage applying process for applying a voltage to an electrode of the electrostatic chuck, to thereby remove electrically charged contaminants in the processing chamber; and a transfer arm returning process for returning the part of the transfer arm having the electrostatic chuck back into the transfer chamber after the transfer arm inserting process and the voltage applying process.

In accordance with an eighth aspect of the present disclosure, there is provided a substrate processing apparatus including a transfer arm that transfers a substrate and has an electrostatic chuck. The substrate processing apparatus includes a controller that performs a control operation for applying, when electrically charged contaminants are adhered on the transfer arm and the substrate is not mounted on the transfer arm, a voltage of the same polarity as that of the electrically charged contaminants to each electrode of the electrostatic chuck, to thereby remove the electrically charged contaminants adhered on the transfer arm.

In accordance with the present disclosure, in the substrate processing apparatus equipped with the transfer arm, contaminants adhered to the transfer arm or contaminants floating within the chamber can be removed easily and quickly by the electrostatic chuck.

### BRIEF DESCRIPTION OF THE DRAWINGS

Non-limiting and non-exhaustive embodiments will be described in conjunction with the accompanying drawings. Understanding that these drawings depict only several embodiments in accordance with the disclosure and are, therefore, not to be intended to limit its scope, the disclosure will be described with specificity and detail through use of the accompanying drawings, in which:

FIG. 1 is a configuration view of a substrate processing apparatus in accordance with a first embodiment of the present disclosure;

FIG. 2 is a top view of a transfer arm;

FIG. 3 is an enlarged cross sectional view of the transfer arm;

FIG. 4 is a flowchart for describing a control method for the substrate processing apparatus in accordance with the first embodiment;

FIG. 5 is a schematic diagram (1) for describing the control method for the substrate processing apparatus in accordance with the first embodiment;

FIG. 6 is a schematic diagram (2) for describing the control method for the substrate processing apparatus in accordance with the first embodiment;

FIG. 7 is a schematic diagram (3) for describing the control method for the substrate processing apparatus in accordance with the first embodiment;

FIG. 8 is a schematic diagram for describing a control method for another substrate processing apparatus in accordance with the first embodiment;

FIG. 9 is a flowchart of a control method for a substrate processing apparatus in accordance with a second embodiment of the present disclosure;

FIG. 10 is a schematic diagram (1) for describing the control method for the substrate processing apparatus in accordance with the second embodiment;

FIG. 11 is a schematic diagram (2) for describing the control method for the substrate processing apparatus in accordance with the second embodiment;

FIG. 12 is a schematic diagram (3) for describing the control method for the substrate processing apparatus in accordance with the second embodiment;

FIG. 13 a schematic diagram (4) for describing the control method for the substrate processing apparatus in accordance with the second embodiment; and

FIG. 14 is a flowchart of a control method for a substrate processing apparatus in accordance with a third embodiment of the present disclosure.

### DETAILED DESCRIPTION OF THE INVENTION

Hereinafter, illustrative embodiments of the present disclosure will be described.

### First Embodiment

A first embodiment will be discussed. The first embodiment relates to a transfer arm cleaning method and a substrate processing apparatus cleaning method for removing contaminants adhered to a transfer arm of a single-sheet-type substrate processing apparatus that transfers a semiconductor wafer by using the transfer arm.

(Substrate Processing Apparatus)

A substrate processing apparatus used in the first embodiment performs a preset process on a substrate such as a semiconductor wafer, and includes a plurality of processing chambers and a transfer chamber connected to the plurality of processing chambers. The transfer chamber is equipped with a transfer arm that attracts and holds the semiconductor wafer by an electrostatic chuck (ESC), and the semiconductor wafer as a substrate can be transferred by the transfer arm between the respective processing chambers or between the processing chambers and load lock chambers.

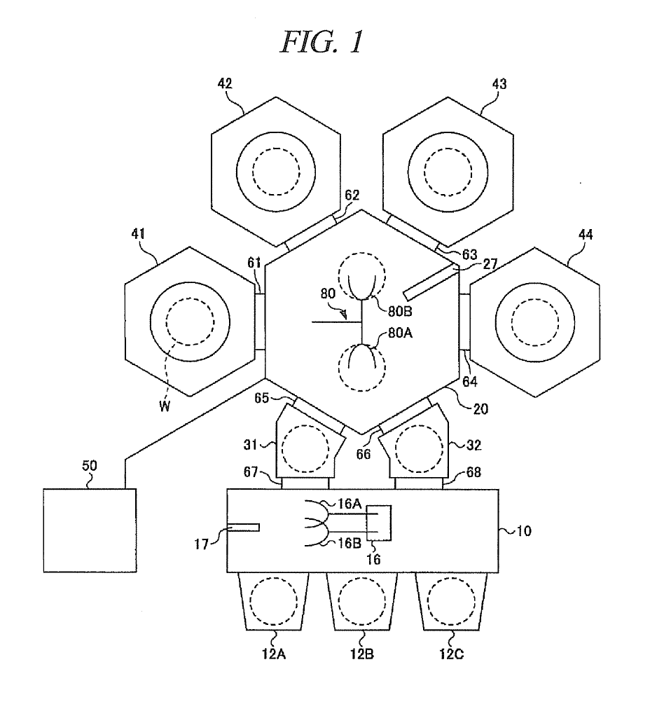

Referring to FIG. 1, the substrate processing apparatus in accordance with the first embodiment will be explained. In this embodiment, the substrate processing apparatus includes a loading transfer chamber 10, a common transfer chamber 20, four processing chambers 41, 42, 43 and 44 and a controller 50. The loading transfer chamber 10 and the common transfer chamber 20 are transfer chambers having transfer mechanisms as will be described later.

The common transfer chamber 20 may have a substantially hexagonal shape, and the four processing chambers 41 to 44 may be connected to four sides of the hexagonal common transfer chamber 20. Further, two load lock chambers 31 and 32 are provided between the common transfer chamber 20 and the loading transfer chamber 10. Gate valves 61, 62, 63 and 64 are provided between the common transfer chamber 20 and the processing chambers 41, 42, 43 and 44, respectively, and, thus, the processing chambers 41 to 44 can be isolated from the common transfer chamber 20. Further, gate valves 65 and 66 are provided between the common transfer chamber 20 and the load lock chambers 31 and 32, respectively, and gate valves 67 and 68 are provided between the load lock chambers 31 and 32 and the loading transfer chamber 10, respectively. Further, a non-illustrated vacuum pump is connected with the common transfer chamber 20 to evacuate the inside of the common transfer chamber 20, and non-illustrated vacuum pumps are also connected with the load lock chambers 31 and 32 to evacuate the inside of the load lock chambers 31 and 32 independently.

Further, three loading ports 12A, 12B and 12C for holding cassettes capable of accommodating a multiple number of semiconductor wafers therein are connected to an opposite side to the loading transfer chamber 10's side where the two load lock chambers 31 and 32 are provided.

A loading transfer mechanism 16 having two transfer arms 16A and 16B for holding a semiconductor wafer W is installed within the loading transfer chamber 10. By extending/retracting, rotating, elevating and also directly moving two transfer arms 16A and 16B, the semiconductor wafer W accommodated in the cassettes on the loading ports 12A to 12C can be taken out and then can be carried into either one of the load lock chambers 31 and 32. Further, a nitrogen supply nozzle 17 configured to jet a nitrogen gas to the transfer arms 16A and 16B is provided within the loading transfer chamber 10.

The common transfer chamber 20 is equipped with a transfer mechanism 80 having two transfer arms 80A and 80B for holding the semiconductor wafer W thereon. By extending/retracting and rotating the transfer arm 80A and 80B, a semiconductor wafer W can be moved between the respective processing chambers 41 to 44, and the semiconductor wafer W can be also moved from the load lock chamber 31 or 32 into one of the respective processing chambers 41 to 44 or from the one of respective processing chambers 41 to 44 into the load lock chamber 31 or 32.

To elaborate, the semiconductor wafer W can be transferred into one of the respective processing chambers 41 to 44 from the load lock chamber 31 or 32 by the transfer arm 80A and 80B, and a process for the semiconductor wafer W may be performed in each of the processing chambers 41 to 44. That is, in order to individually process the semiconductor wafer W in the respective processing chambers 41 to 44, the semiconductor wafer W needs to be transferred between the processing chambers 41 to 44 by the transfer arm 80A and 80B. After the processes for the semiconductor wafer W are completed, the processed semiconductor wafer W is moved into the load lock chamber 31 or 32 from the processing chamber 41, 42, 43 or 44 by the transfer arm 80A or 80B and then is accommodated in the cassette on the loading port 12A, 12B or 12C by the transfer arm 16A or 16B of the loading transfer mechanism 16 in the loading transfer chamber 10. Further, a nitrogen supply nozzle 27 configured to jet a nitrogen gas to the transfer arm 80A and 80B is provided within the common transfer chamber 20.

Furthermore, the controller 50 may control operations of the transfer arms 16A and 16B in the loading transfer mechanism 16, operations of the transfer arms 80A and 80B in the transfer mechanism 80, processes of the semiconductor wafer in the processing chambers 41 to 44, operations of the gate valves 61 to 68, and evacuation of the load lock chambers 31 and 32. Further, the controller 50 may also control application of a preset voltage to electrodes for electrostatic chucks in the transfer arms 16A and 16B and the transfer arms 80A and 80B.

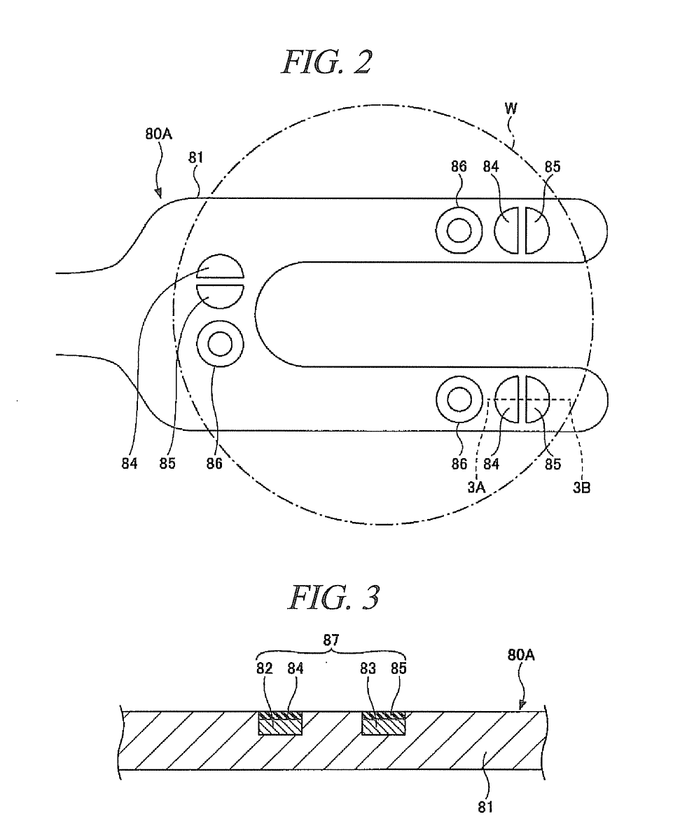

Now, referring to FIGS. 2 and 3, the transfer arm 80A in accordance with the first embodiment will be explained in detail. FIG. 3 is a cross sectional enlarged view taken along a dashed line 3A-3B of FIG. 2. The transfer arm 80A has a forked U-shaped leading end on which a semiconductor wafer W is mounted. A main body 81 of the transfer arm 80A is made of a ceramic material such as aluminum oxide and is provided with the U-shaped leading end for holding the semiconductor wafer W thereon. Metal electrodes 82 and 83 for electrostatic chuck are provided in the U-shaped leading end, and insulating layers 84 and 85 made of polyimide are formed on surfaces of the electrodes 82 and 83, respectively. Further, O-rings 86 made of silicon-based rubber containing a silicon compound are provided on a wafer attracting surface of the main body 81 of the transfer arm 80A, and, thus, the semiconductor wafer W is prevented from coming into direct contact with the main body 81. Moreover, the electrostatic chuck function may be performed by electrostatic chuck members 87 having the electrodes 82 and 83 and the insulating layers 84 and 85 made of polyimide and formed on surfaces of the electrodes 82 and 83. Further, the transfer arm 80B and the transfer arms 16A and 16B of the loading transfer mechanism 16 may have the same configuration as that of the transfer arm 80A. In addition, positions for removing contaminants adhered to the transfer arms 80A and 80B by a nitrogen gas may be set to be in the vicinity of a non-illustrated exhaust port installed in each unit, at a position retracted from the processing chambers 41 to 44, or in the vicinity of a nitrogen gas supply port.

(Control Method for the Substrate Processing Apparatus)

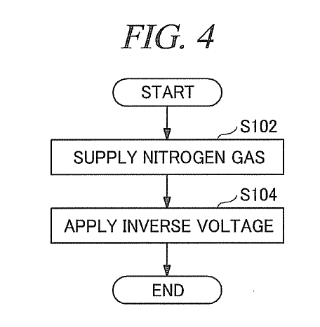

Now, a control method for the substrate processing apparatus in accordance with the present embodiment will be described. FIG. 4 is a flowchart for describing the control method for the substrate processing apparatus in accordance with the first embodiment.

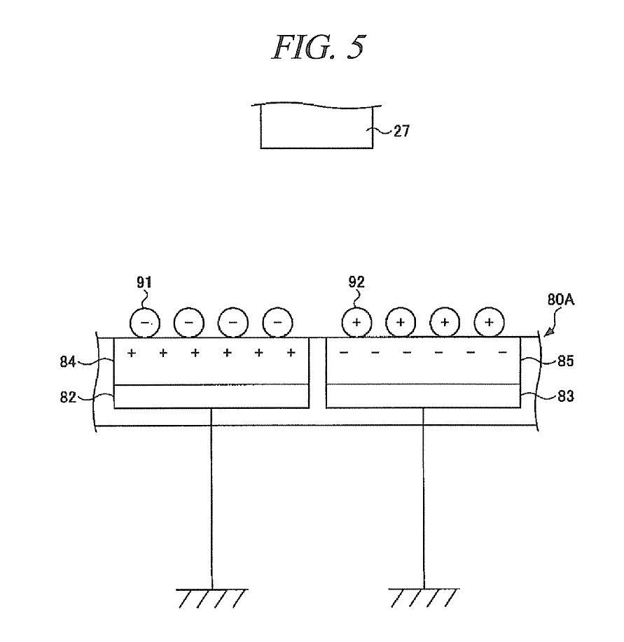

Since the transfer arm 80A performs electrostatic chuck operation for the semiconductor wafer W repetitively, the insulating layers 84 and 85 may be left electrically charged. Even when no voltage is applied to the electrodes 82 and 83 (i.e., even when a voltage of 0 is applied thereto), negatively charged contaminants 91 and positively charged contaminants 92 as foreign substances may be adhered to surfaces of the insulating layers 84 and 85, as illustrated in FIG. 5.

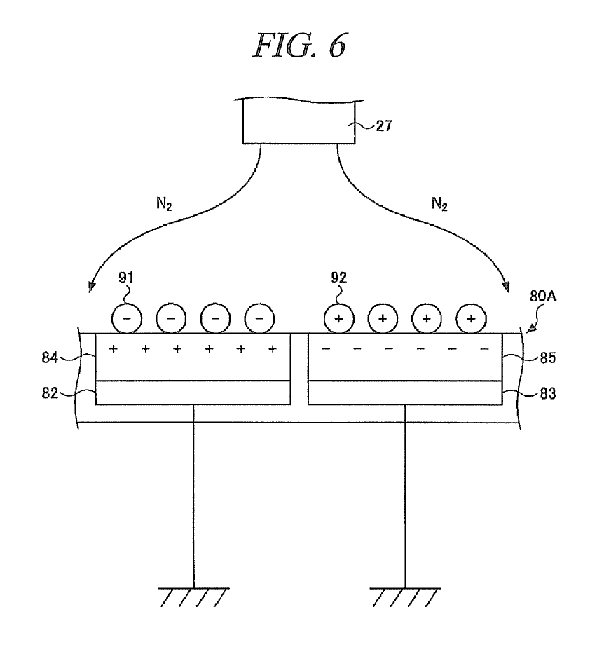

First, in step 102 (S102), a nitrogen gas is jetted to the transfer arm 80A on which the negatively charged contaminants 91 and the positively charged contaminants 92 are adhered. To be specific, as illustrated in FIG. 6, a nitrogen gas is supplied from the nitrogen supply nozzle 27 and is jetted to the U-shaped leading end of the transfer arm 80A from the top of the transfer arm 80A (gas supplying process).

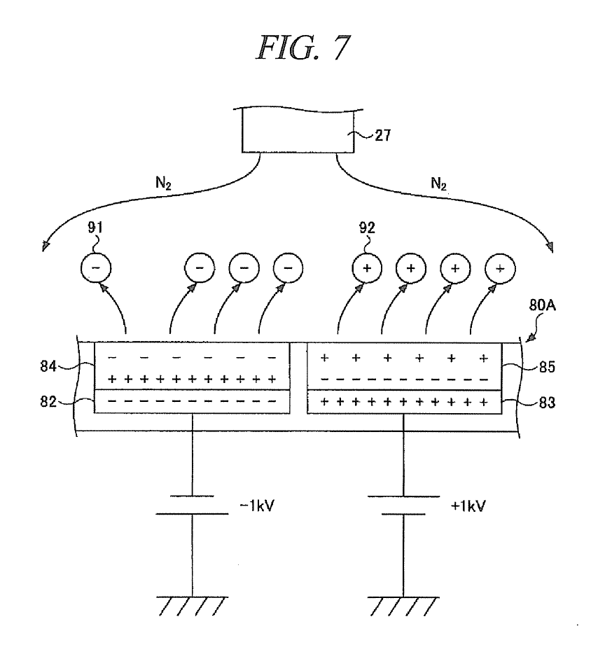

Then, in step 104 (S104), voltages of the same polarities as those of electric charges of the charged contaminants 91 and 92 are applied to the electrodes 82 and 83, respectively, such that polarities of the surfaces of the charged insulating layers 84 and 85 become reversed (voltage applying process). Specifically, as depicted in FIG. 7, a negative voltage is applied to the electrode 82 of the transfer arm 80A, whereas a positive voltage is applied to the electrode 83 of the transfer arm 80A.

By applying the negative voltage to the electrode 82, the surface of the insulating layer 84 of the transfer arm 80A becomes negatively charged, and, thus, the negatively charged contaminants 91 adhered on the surface of the insulating layer 84 may be repelled by an electric force and separated from the surface of the insulating layer 84 of the transfer arm 80A. The nitrogen gas is jetted to the surface of the transfer arm 80A from the nitrogen supply nozzle 27, and the negatively charged contaminants 91 separated from the surface of the insulating layer 84 may be removed by being carried away by a flow of the nitrogen gas supplied from the nitrogen supply nozzle 27.

Likewise, by applying the positive voltage to the electrode 83, the surface of the insulating layer 85 of the transfer arm 80A becomes positively charged, and, thus, the positively contaminants 92 adhered on the surface of the insulating layer 85 may be repelled by an electric force and separated from the surface of the insulating layer 85 of the transfer arm 80A. The nitrogen gas is jetted to the surface of the transfer arm 80A from the nitrogen supply nozzle 27, and the positively charged contaminants 92 separated from the surface of the insulating layer 85 may be removed by being carried away by the flow of the nitrogen gas supplied from the nitrogen supply nozzle 27.

As discussed above, the negatively charged contaminants 91 and the positively charged contaminants 92 adhered on the surface of the transfer arm 80A can be removed by the control method for the substrate processing apparatus in accordance with the present embodiment.

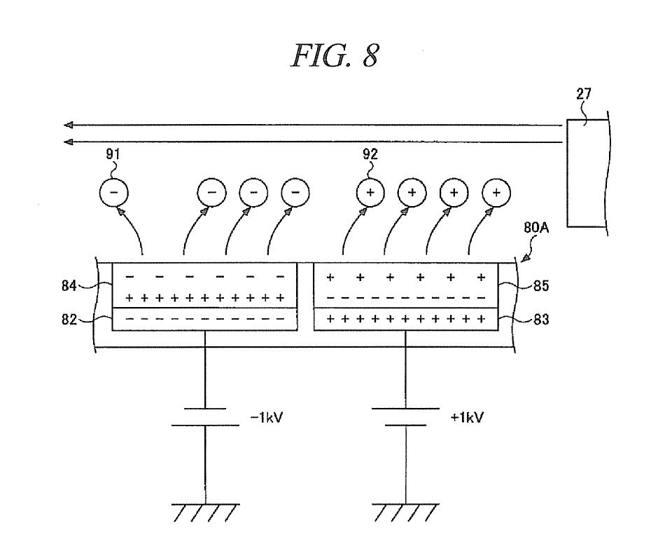

Although it has been described above that the nitrogen supply nozzle 27 supplies the nitrogen gas to the surface of the transfer arm 80A from the top of the transfer arm 80A (from vertically above the transfer arm 80A to a surface of the transfer arm 80A), the nitrogen supply nozzle 27 may be installed at a lateral side of the transfer arm 80A as shown in FIG. 8. In such a case, the nitrogen gas supplied from the nitrogen supply nozzle 27 may flow in the surface direction of the transfer arm 80A, and, thus, the negatively charged contaminants 91 and the positively charged contaminants 92 separated from the transfer arm 80A as a result of the voltage application may be flown away and removed by the nitrogen gas.

Moreover, although the above detailed description has been provided for the transfer arm 80A, the same control method may be applied to the transfer arm 80B. Further, in a case of the transfer arms 16A and 16B of the loading transfer mechanism 16, contaminants adhered on surfaces of the transfer arms 16A and 16B may also be removed by using the nitrogen supply nozzle 17, as in the case of the transfer arm 80A.

### Second Embodiment

Now, a second embodiment will be described. The present embodiment relates to a transfer arm cleaning method and a substrate processing apparatus cleaning method for removing contaminants within chambers (processing chambers, a common transfer chamber, load lock chambers and a loading transfer chamber) of a single-sheet-type substrate processing apparatus that transfers a semiconductor wafer by using a transfer arm. Further, the transfer arm cleaning method and the substrate processing apparatus cleaning method of the present embodiment are performed by utilizing the same substrate processing apparatus as used in the first embodiment.

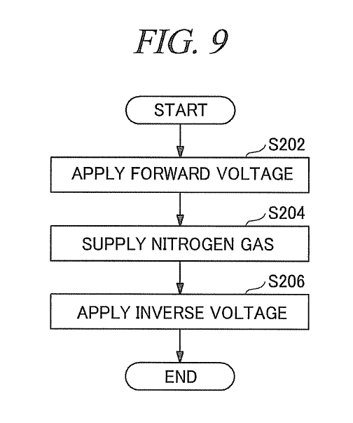

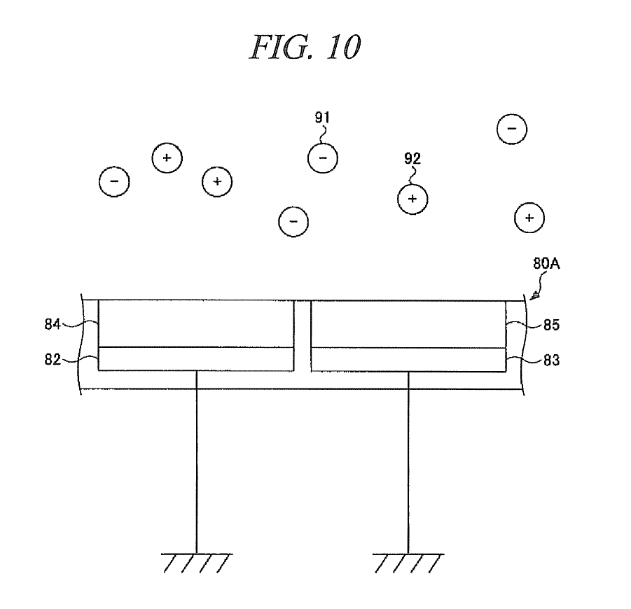

Referring to FIG. 9, a control method for the substrate processing apparatus in accordance with the present embodiment will be explained. As depicted in FIG. 10, when voltages are not applied to the electrodes 82 and 83 of the transfer arm 80A and no electric charges remain on surfaces of the insulating layers 84 and 85, negatively charged contaminants 91 and positively charged contaminants 92 may float within chambers without being adhered to the transfer arm 80A.

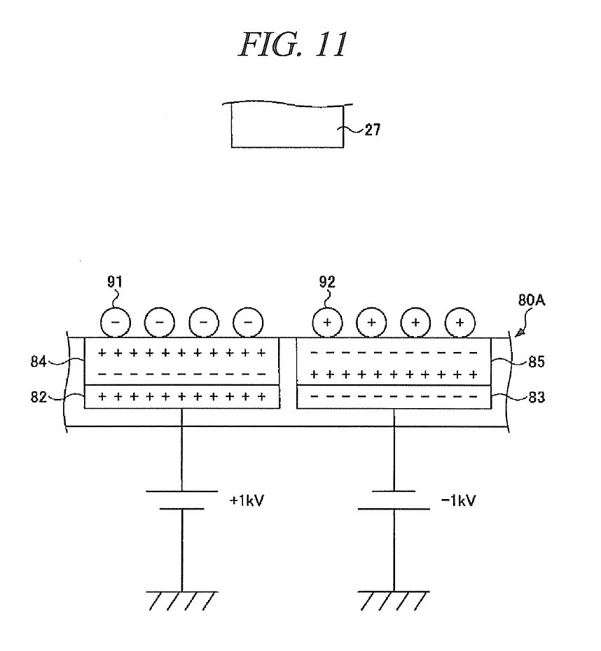

First, in step 202 (S202), voltages are applied to the electrodes 82 and 83 (first voltage applying process). To elaborate, as illustrated in FIG. 11, a positive voltage is applied to the electrode 82, while a negative voltage is applied to the electrode 83. This voltage application may be referred to as forward voltage application. By applying the positive voltage to the electrode 82, the surface of the insulating layer 84 becomes positively charged, and the negatively charged contaminants 91 are adhered to the surface of the insulating layer 84. Further, by applying the negative voltage to the electrode 83, the surface of the insulating layer 85 becomes negatively charged, and the positively charged contaminants 92 are adhered to the surface of the insulating layer 85.

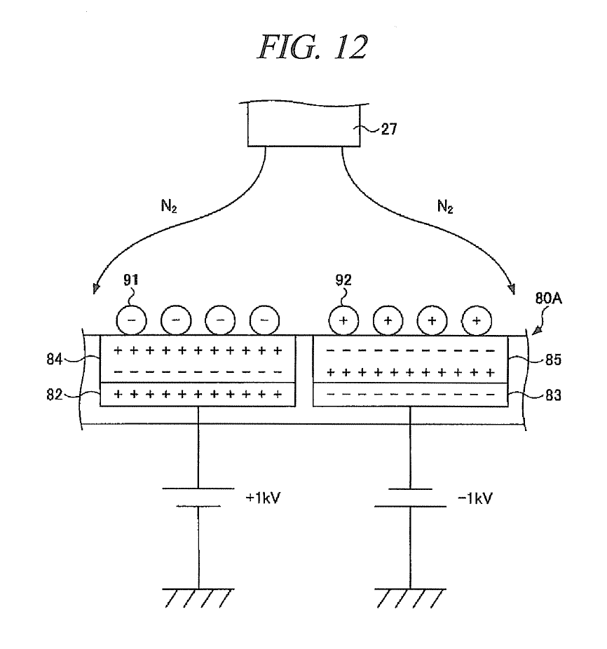

Subsequently, in step 204 (S204), a nitrogen gas is jetted to the transfer arm 80A on which the negatively charged contaminants 91 and the positively charged contaminants 92 are adhered (gas supplying process). To be specific, as illustrated in FIG. 12, a nitrogen gas is supplied from the nitrogen supply nozzle 27 and is jetted from the top of the transfer arm 80A.

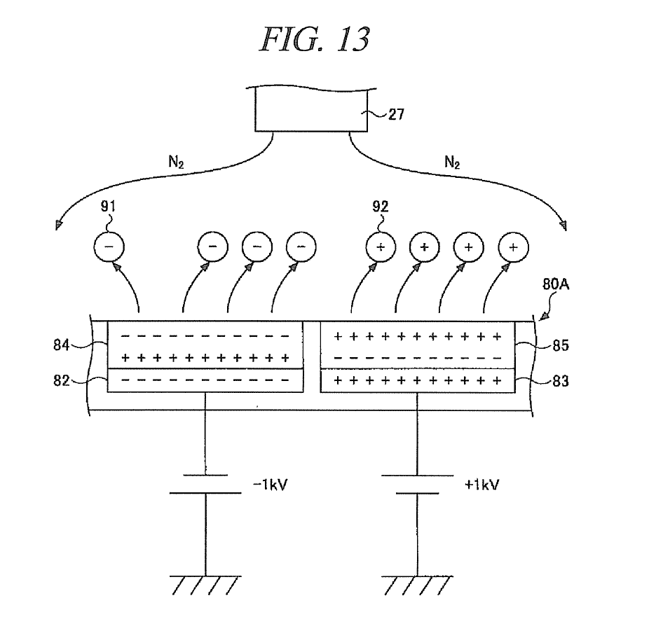

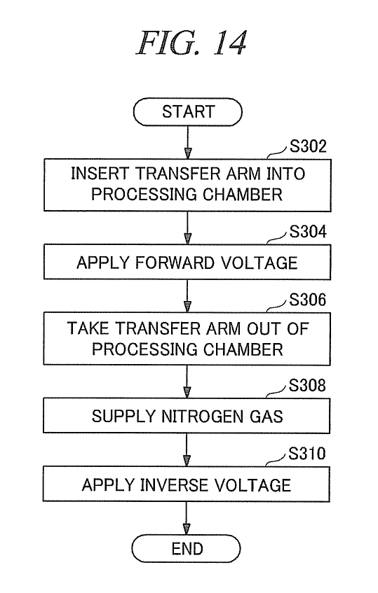

Thereafter, in step 206 (S206), voltages are applied to the electrodes 82 and 83, respectively, such that polarities of the charged insulating layers 84 and 85 become reversed, while the nitrogen gas is being supplied (second voltage applying process). To be specific, as shown in FIG. 13, voltages of reverse polarities to those in step 202 are applied to the electrodes 82 and 83 of the transfer arm 80A. This voltage application may be referred to as inverse voltage application. By applying a negative voltage to the electrode 82, the surface of the insulating layer 84 of the transfer arm 80A becomes negatively charged, and, thus, the negatively charged contaminants 91 adhered on the surface of the insulating layer 84 may be repelled by an electric force and separated from the surface of the insulating layer 84 of the transfer arm 80A. The nitrogen gas is jetted to the surface of the transfer arm 80A from the nitrogen supply nozzle 27, and the negatively charged contaminants separated from the surface of the insulating layer 84 may be removed from the chamber by being carried away by a flow of the nitrogen gas supplied from the nitrogen supply nozzle 27.

Likewise, by applying a positive voltage to the electrode 83, the surface of the insulating layer 85 of the transfer arm 80A becomes positively charged, and, thus, the positively contaminants 92 adhered on the surface of the insulating layer 85 may be repelled by an electric force and separated from the surface of the insulating layer 85 of the transfer arm 80A. The nitrogen gas is jetted to the surface of the transfer arm 80A from the nitrogen supply nozzle 27, and the positively charged contaminants 92 separated from the surface of the insulating layer 85 may be removed from the chamber by being carried away by the flow of the nitrogen gas supplied from the nitrogen supply nozzle 27.

As stated above, the negatively charged contaminants and the positively charged contaminants 92 floating around the transfer arm 80A are once attracted and adhered to the surface of the transfer arm 80A. Then, by flowing away those contaminants by the nitrogen gas jetted from the nitrogen supply nozzle 27, the contaminants within the chambers can be removed.

Further, although it has been described above that the nitrogen supply nozzle 27 supplies the nitrogen gas to the surface of the transfer arm 80A from the top of the transfer arm 80A (from vertically above the transfer arm 80A to a surface of the transfer arm 80A), the nitrogen supply nozzle 27 may be installed at a lateral side of the transfer arm 80A. Further, the contaminants within the chambers can also be removed by applying inverse voltages in the first voltage applying process and applying forward voltages in the second voltage applying process.

Moreover, although the above detailed description has been provided for the transfer arm 80A, the same control method may be applied to the transfer arm BOB. Further, in a case of the transfer arms 16A and 16B of the loading transfer mechanism 16, contaminants may also be removed by a nitrogen gas from the nitrogen supply nozzle 17 by using the transfer arms 16A and 16B in the same manner as the transfer arm 80A.

### Third Embodiment

Now, a third embodiment will be described. Particularly, the present embodiment relates to a method for removing contaminants within chambers (processing chambers and load lock chambers) not having a transfer arm in the second embodiment. Further, a substrate processing apparatus cleaning method in accordance with the present embodiment is performed by utilizing the same substrate processing apparatus as used in the first embodiment.

A control method for the substrate processing apparatus in accordance with the present embodiment will be explained.

First, in step 302 (S302), the gate valve 61 is opened, and the U-shaped leading end of the transfer arm 80A is inserted into the processing chamber 41 from the common transfer chamber 20 (transfer arm inserting process).

Then, in step 304 (S304), voltages are applied to the electrodes 82 and 83 (first voltage applying process). To elaborate, a positive voltage is applied to the electrode 82, while a negative voltage is applied to the electrode 83. This voltage application may be referred to as forward voltage application. By applying the positive voltage to the electrode 82, the surface of the insulating layer 84 becomes positively charged, and the negatively charged contaminants 91 are adhered on the surface of the insulating layer 84. Further, by applying the negative voltage to the electrode 83, a surface of the insulating layer 85 becomes negatively charged, and the positively charged contaminants 92 are adhered on the surface of the insulating layer 85.

Subsequently, in step 306 (S306), the U-shaped leading end of the transfer arm 80A is returned back into the common transfer chamber 20 from the processing chamber 41, and the gate valve 61 is closed (transfer arm returning process).

Then, in step 308 (S308), a nitrogen gas is jetted to the transfer arm 80A on which the negatively charged contaminants 91 and the positively charged contaminants 92 are adhered. To be specific, the nitrogen gas is supplied from the nitrogen supply nozzle 27 and is jetted to the U-shaped leading end of the transfer arm 80A from the top of the transfer arm 80A (gas supplying process).

Thereafter, in step 310 (S310), voltages are applied to the electrodes 82 and 83, respectively, such that polarities of the charged insulating layers 84 and 85 become reversed, while the nitrogen gas is being supplied. That is, voltages of reverse polarities to those applied in step 304 are applied (second voltage applying process). This voltage application may be referred to as inverse voltage application. As a result, the negatively charged contaminants 91 and the positively charged contaminants 92 adhered on the surface of the transfer arm 80A may be separated from the transfer arm 80A and can be removed by the nitrogen gas supplied from the nitrogen supply nozzle 27.

Through the aforementioned processes, the negatively charged contaminants 91 and the positively charged contaminants 92 can be removed from the processing chamber 41.

Further, although it has been described above that the nitrogen supply nozzle 27 supplies the nitrogen gas to the surface of the transfer arm 80A from the top of the transfer arm 80A (from vertically above the transfer arm 80A to a surface of the transfer arm 80A), the nitrogen supply nozzle 27 may be installed at a lateral side of the transfer arm 80A. Further, the contaminants within the chamber can also be removed by applying inverse voltages in the first voltage applying process and applying forward voltages in the second voltage applying process.

Moreover, although the above detailed description has been provided for the transfer arm 80A, the same control method may be applied to the transfer arm 80B, and contaminants can be removed from the processing chambers 42 to 44 and the load lock chambers 31 and 32 by using the same method. Further, in a case of the transfer arms 16A and 16B of the loading transfer mechanism 16, contaminants may also be removed by using the transfer arms 16A and 16B in the same manner as the transfer arm 80A. Besides, the transfer arms 16A and 16B may be used for the removal of contaminants of the load lock chambers 31 and 32. The other control method except that described above is the same as that of the second embodiment.

Although the embodiments of the present disclosure have been described, the present disclosure is not limited to the above-stated embodiments.

What is claimed is:

1. A cleaning method for a transfer arm that transfers a substrate and has an electrostatic chuck, the method comprising:
a voltage applying process for applying, when electrically charged contaminants are adhered on the transfer arm and the substrate is not mounted on the transfer arm, a voltage of the same polarity as that of the electrically charged contaminants to each electrode of the electrostatic chuck, to thereby remove the contaminants adhered on the transfer arm.

2. The cleaning method of claim 1, further comprising:
a gas supplying process for supplying a gas toward the electrostatic chuck of the transfer arm before the voltage applying process,
wherein the gas supplying process is started before the voltage applying process and the gas supplying process is continued during the voltage applying process.

3. A cleaning method for a transfer arm that transfers a substrate and has an electrostatic chuck, the method comprising:
a first voltage applying process for applying a positive voltage to one of electrodes of the electrostatic chuck and applying a negative voltage to the other one of the electrodes of the electrostatic chuck while the substrate is not mounted on the transfer arm; and
a second voltage applying process for applying a negative voltage to the one electrode of the electrostatic chuck and applying a positive voltage to the other electrode of the electrostatic chuck after the first voltage applying process, to thereby remove contaminants around the transfer arm.

4. The cleaning method of claim 3, further comprising:
a gas supplying process for supplying a gas toward the electrostatic chuck of the transfer arm after the first voltage applying process,
wherein the gas supplying process is started before the second voltage applying process and the gas supplying process is continued during the second voltage applying process.

5. The cleaning method of claim 2, wherein the gas supplied in the gas supplying process is a nitrogen gas.

6. The cleaning method of claim 2, wherein the gas in the gas supplying process is supplied from a gas supply nozzle, and
the gas supply nozzle is provided on a side facing a surface of the transfer arm on which the electrostatic chuck is installed or on a lateral side of the surface of the transfer arm on which the electrostatic chuck is installed.

7. A cleaning method for a substrate processing apparatus including a plurality of processing chambers for performing a process on a substrate, a transfer chamber connected to the plurality of processing chambers, and a transfer arm installed in the transfer chamber to transfer the substrate between the processing chambers and having an electrostatic chuck, the method comprising:
a voltage applying process for applying, when electrically charged contaminants are adhered on the transfer arm and the substrate is not mounted on the transfer arm, a voltage of the same polarity as that of the electrically charged contaminants to each electrode of the electrostatic chuck, to thereby remove the contaminants adhered on the transfer arm.

8. A cleaning method for a substrate processing apparatus including a plurality of processing chambers for performing a process on a substrate, a transfer chamber connected to the plurality of processing chambers, a load lock chamber connected to the transfer chamber, and a transfer arm installed in the transfer chamber to transfer the substrate between the processing chambers and the load lock chamber and having an electrostatic chuck, the method comprising:
a voltage applying process for applying, when electrically charged contaminants are adhered on the transfer arm and the substrate is not mounted on the transfer arm, a voltage of the same polarity as that of the electrically charged contaminants to each electrode of the electrostatic chuck, to thereby remove the contaminants adhered on the transfer arm.

9. The cleaning method of claim 7, further comprising:
a gas supplying process for supplying a gas toward the electrostatic chuck of the transfer arm before the voltage applying process,
wherein the gas supplying process is started before the voltage applying process and the gas supplying process is continued during the voltage applying process.

10. A cleaning method for a substrate processing apparatus including a plurality of processing chambers for performing a process on a substrate, a transfer chamber connected to the plurality of processing chambers, and a transfer arm installed in the transfer chamber to transfer the substrate between the processing chambers and having an electrostatic chuck, the method comprising:
a first voltage applying process for applying a positive voltage to one of electrodes of the electrostatic chuck while applying a negative voltage to the other one of the electrodes of the electrostatic chuck while the substrate is not mounted on the transfer arm; and
a second voltage applying process for applying a negative voltage to the one electrode of the electrostatic chuck while applying a positive voltage to the other electrode of the electrostatic chuck after the first voltage applying process, to thereby remove electrically charged contaminants in the processing chambers or in the transfer chamber.

11. A cleaning method for a substrate processing apparatus including a plurality of processing chambers for performing a process on a substrate, a transfer chamber connected to the plurality of processing chambers, a load lock chamber connected to the transfer chamber, and a transfer arm installed in the transfer chamber to transfer the substrate between the processing chambers and the load lock chamber and having an electrostatic chuck, the method comprising:
a first voltage applying process for applying a positive voltage to one of electrodes of the electrostatic chuck and applying a negative voltage to the other one of the electrodes of the electrostatic chuck while the substrate is not mounted on the transfer arm; and
a second voltage applying process for applying a negative voltage to the one electrode of the electrostatic chuck while applying a positive voltage to the other electrode of the electrostatic chuck after the first voltage applying process, to thereby remove electrically charged contaminants in the processing chambers or in the transfer chamber.

12. The cleaning method of claim 10, further comprising:
a gas supplying process for supplying a gas toward the electrostatic chuck of the transfer arm before the second voltage applying process and after the first voltage applying process,
wherein the gas supplying process is started before the second voltage applying process and the gas supplying process is continued during the second voltage applying process.

13. The cleaning method of claim 11, further comprising:
a gas supplying process for supplying a gas toward the electrostatic chuck of the transfer arm before the second voltage applying process and after the first voltage applying process,
wherein the gas supplying process is started before the second voltage applying process and the gas supplying process is continued during the second voltage applying process.

14. A cleaning method for a substrate processing apparatus including a plurality of processing chambers for performing a process on a substrate, a transfer chamber connected to the plurality of processing chambers, and a transfer arm installed in the transfer chamber to transfer the substrate between the processing chambers and having an electrostatic chuck, the method comprising:
a transfer arm inserting process for inserting a part of the transfer arm having the electrostatic chuck into the processing chamber from the transfer chamber while the substrate is not mounted on the transfer arm;
a voltage applying process for applying a voltage to an electrode of the electrostatic chuck, to thereby remove electrically charged contaminants in the processing chamber; and
a transfer arm returning process for returning the part of the transfer arm having the electrostatic chuck back into the transfer chamber after the transfer arm inserting process and the voltage applying process.

15. The cleaning method of claim 14, further comprising:
a gas supplying process for supplying a gas toward the electrostatic chuck of the transfer arm after the transfer arm returning process.

16. The cleaning method of claim 9, wherein the gas supplied in the gas supplying process is a nitrogen gas.

17. The cleaning method of claim 9, wherein the gas in the gas supplying process is supplied from a gas supply nozzle, and
the gas supply nozzle is provided on a side facing a surface of the transfer arm on which the electrostatic chuck is installed or on a lateral side of the surface of the transfer arm on which the electrostatic chuck is installed.

18. A substrate processing apparatus including a transfer arm that transfers a substrate and has an electrostatic chuck, the apparatus comprising:
a controller that performs a control operation for applying, when electrically charged contaminants are adhered on the transfer arm and the substrate is not mounted on the transfer arm, a voltage of the same polarity as that of the electrically charged contaminants to each electrode of the electrostatic chuck, to thereby remove the electrically charged contaminants adhered on the transfer arm.
